(19) United States
(12) Patent Application Publication
(10) Pub. No.: US 2003/0093506 A1
(43) Pub. Date: May 15, 2003

(54) Systems operation module

(75) Inventors: Jeffrey Oliver, Tustin, CA (US); Raymond Diaz, Irving, CA (US)

Correspondence Address: Fogg, Slifer & Polglaze, P.A., P.O. Box 581009, Minneapolis, MN, 55458-1009, US

(73) Assignee: ADC DSL Systems, Inc.

(21) Appl. No.: 10/008,932

(22) Filed: Nov. 9, 2001

(51) Int. Cl. G06F 15/177

(52) U.S. Cl. 709/221

(57) ABSTRACT

A systems operation module for a telecommunications system gathers all system change event code into one central location, and performs a series of checks and configuration modifications centrally. When the changes have been validated and the system updated, the systems operation module writes a new configuration to the system information database.

The present invention relates generally to telecommunications, and more specifically to functional operation of a telecommunications system.

### BACKGROUND

Telecommunications systems are increasingly complex, performing multiple functions to meet multiple different user requirements, as well as standards and protocols, all of which change over time, by adding functionality, changing operational characteristics, and the like. As standards, protocols, and the like change and evolve, and as new functions are added to telecommunications systems, the integration of the new or changed functions or modules also becomes increasingly more complex.

This is due to the architecture of telecommunications systems. In a typical telecommunications system architecture, a loose definition of functions is usually present, and the system is arranged so that every function, typically operated by a function module, is integrated with every other function with which it needs to interact trough a jumble of code. This code is distributed among the many different modules. When a change is desired to be made to a telecommunications system that will affect the system as a whole, such as a provisioning change, a loopback activation or deactivation event, an alarm event or the like, each piece of code that is distributed around the system must be identified and modified to accommodate the change.

This modification is time consuming, and if even one of the many blocks of code that allow system operation is changed, all system code must be checked to ensure that no piece of code that relies upon the changed code is in need of modification. With the code spread throughout many modules of the system, it is often very expensive and time intensive to effect changes to an existing telecommunications system.

There is therefore a need in the art for a telecommunications system or apparatus that allows changes that affect the entire system to be centralized in order to ease the constraints on such changes.

### SUMMARY

In one embodiment, a method for effecting a configuration change in a telecommunications system includes receiving a request for a system change, performing a number of checks to determine if the current setting of the particular configuration allows the requested change, updating the system, and carrying out the requested change.

In another embodiment, a method for operating a systems operation module in a telecommunications system includes receiving a request for a system change, determining changes to be made to the system to effect the system change, and making the system change.

In still another embodiment, a systems operation module for a telecommunications system includes a systems operation application interface to provide access functions for the system, and a systems operation manager to control system operation.

In yet another embodiment, a telecommunications system includes a system information database containing configuration information for the system, a number of modules to perform individual system functions, and a systems operation module between the modules and the system information database. The systems operation module controls all system change events.

In still yet another embodiment, a computer program includes instructions for performing a method. The method includes performing a number of checks to determine if the current setting of the particular configuration allows the requested change, updating the system, and carrying out the configuration change.

Other embodiments are described and claimed.

### BRIEF DESCRIPTION OF THE DRAWINGS

FIG. 1 is a block diagram of a telecommunications system according to one embodiment of the present invention;

FIG. 2 is a block diagram of a systems operation module according to one embodiment of the present invention;

FIG. 3 is a flow chart diagram of a method according to one embodiment of the present invention; and

FIG. 4 is a block diagram of a computer on which embodiments of the present invention are employed.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various embodiments of the present invention place the various functions in a telecommunications system that affect its operation in a single, central location. When an event occurs that affects the system, such as a configuration change, provisioning change, loopback event, alarm event, or the like, rules for the system parameters are consulted, the parameters are set and changed according to the parameter settings available, and the interaction between all of the various rules sets is reconciled.

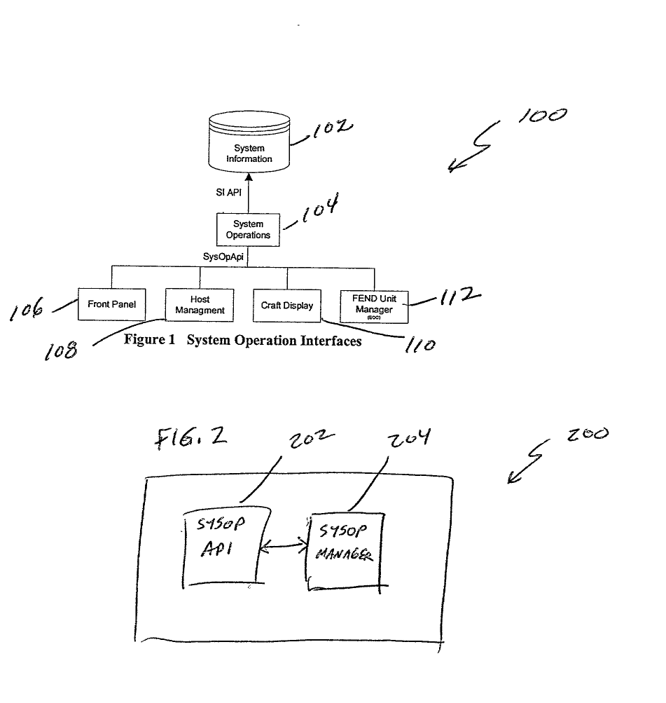

FIG. 1 is a block diagram of a basic telecommunications system 100 having a system information database 102 connected to a systems operation module 104. in turn, the systems operation module 104 is connected via a systems operation application interface (API) to a plurality of modules including a front panel 106, a host management module 108, a craft display 110, and a far end (FEND) unit manager 112. In this embodiment, the systems operation module 104 is a module, described further below, that gathers together all of the system operations that involve changing the system.

The systems operation module 104 is a central point for configuring or changing the state of the system 100. Instead of having functions or operations that are distributed among many different modules throughout the entire system, with no easy way for determining what to do in the event of a system change, the functions or operations that involve system changes are centralized. The systems operation module 104 addresses those functions of operations that change the state of the system.

FIG. 2 is a block diagram of a systems operation module 200 according to one embodiment of the present invention. Systems operation module 200 comprises two parts, a systems operation application interface 202 and a systems operation manager 204. The systems operation API provides access functions to other applications within the system, such as system 100, to initiate a system operation. The systems operation manager 204 ensures that the operation is executed properly.

When a particular operation is to be performed, a systems operation API call is made requesting the desired operation. The API call performs system checks to determine whether the operation can be performed, that is if the operation as it is desired is allowed by the current system configuration. If the operation can be performed, the systems operation module updates the system information database (FIG. 1), and other modules in the system are detailed to performing the operation.

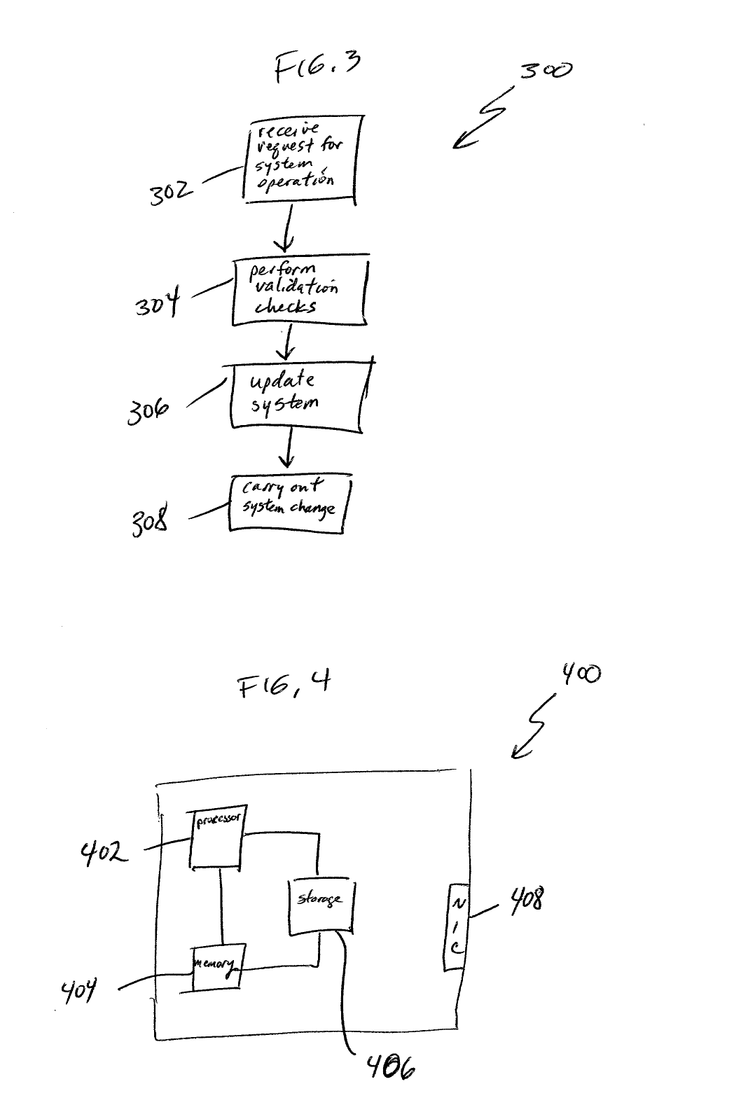

Operation of the systems operation module is shown in greater detail in the flow chart diagrams of FIG. 3. FIG. 3 is a flow chart diagram of a method 300 according to one embodiment of the present invention. Method 300 for effecting a change in a telecommunications system comprises receiving a request for a system operation, such as a system change event, in block 302, and performing a plurality of checks to determine if the current setting of the particular configuration allows the requested change in block 304. The system is updated in block 306, and the system or configuration change is carried out in block 308.

The block 304 comprises performing a series of checks on the system to determine whether an operation can be performed. Potential operations that affect the system as a whole include by way of example and not by way of limitation changing a configuration or provisioning it, performing a loopback, reporting an alarm, or the like. This is referred to also as validation. In validation, the module checks to see if the setting of the particular configuration, setting of the particular loopback, or the like, is allowed by the current configuration of the system.

The block 306 comprises updating the system. Updating includes modifying the rules that govern the rest of the validation. Each system contains a number of rules that determine whether or not certain pieces of configuration, loopbacks, or alarms can be set. When one piece of configuration changes, it might change the rules for some other piece of configuration.

The block 308 comprises carrying out the configuration change. Once the change has been validated and any rules for any other portion of the module have been changed in blocks 304 and 306, the configuration change is stored, and other pieces of hardware in the system that are affected by the change are instructed by the module to make appropriate changes.

In greater detail, the operation of each of the blocks 304, 306, and 308 is described below. For the validation operation, the systems operation module contains a list, in a database or other such storage medium, having information on all of the configuration parameters, the available loopbacks, the different alarms and alarm reporting information for the entire system, all in one central location. For each one of those configuration pieces, alarms, loopbacks, and the like, there is a set of rules that is followed for interaction between the particular operation and other operations of the system.

Depending upon what the user has selected for their operation, that is their configuration for their system, certain other parameters of the system may or may not be valid anymore. Since the telecommunications system performs many operations, and has many features, the systems operation module controls how the user is allowed to configure the system. In other words, the user is not allowed to perform an operation or a configuration which would render the system inoperative, unable to write data, or the like. Because of this system of validation, the user does not need to know every detail about the system and its operations. If the user does not require a feature, it is not enabled, and the systems operation module recognizes this and adjusts available parameters accordingly.

In one embodiment, the list of parameters and the like is a database that is cross referenced so that the systems operation module knows how one operation affects the other operations of the system. There is a collection of validation rules for each parameter that is set up on startup of the system. As the configuration changes, that is as the user sits at a craft interface, or other user terminal for interaction with the system, and as the user changes parameters, the systems operation module dynamically changes the rules throughout the system so that the user does not create a configuration that prohibits proper operation of the system. This is seamless to the user. For instance, if the user configures one parameter, and the configuration affects a second parameter, when the user attempts to change the second parameter, parameter configuration choices that would result in an inoperative system are no longer available as options. The systems operation module validation and updating process prohibits the user from creating an inoperative system. The rules that conflict with a current system change event are modified so as not to allow a change that creates a conflict.

The updating process functions as follows. It consists of two separate parts, changing the validation rules for other parameters in the system depending upon a current system change, and actually changing the current setting of these other parameters. When the user changes one parameter, it may affect many other parameters of the system. The change may not affect the actual setting of the parameter or parameters, but may affect the total valid options for the particular parameter. In updating, the rules for other parameters affected by the current system change are modified once a particular change has been validated. In some instances of system changes, when one parameter is configured and validated, it may be required that a different parameter's setting must be changed to maintain an operating system. In this instance, the actual setting of the other parameter is changed to conform to the possible new rules imposed on the parameter, and to avoid an invalid system operation.

The configuration change process functions as follows. Once the proposed or desired system change event is validated and updated, the configuration change is written to the configuration database, along with the changed rules and newly selected parameter settings. This writing of information to the configuration database triggers in some embodiments other events, including changing the hardware configuration of the system.

An operational example of a change event is described below with respect to Table 1, which contains a subset of configuration rules and parameters for a telecommunications system.

TABLE 1

| Parameter | Parameter Setting | Prerequisites |
|---|---|---|
| CRC4_MODE | ENABLE | E1_TS < 32 |
| | DISABLE | E1_TS < 32 |
| | PASSTHRU | E1_TS < 32 |
| | NOT AVAILABLE | E1_TS = 32 |
| NUM_X1_TS | 0..32 | None |

In the example, the user desires to change the number of x1 time slots (NUM_X1_TS) in the system. The NUM_{—X1}_TS parameter has as a valid rule governing it a range of values from 0 to 32, as designated in the parameter setting column of the database subsection of Table 1. It should be understood that changes to a parameter involve the changing in some instances of many different parameters, but that only one such change is shown for purposes of brevity herein.

The range of values from 0 to 32 for NUM_X1_TS is used for validation. If the user enters a number of time slots the user wishes to use on the E1 interface of the system, and the number entered is within the range of 0 to 32, the parameter setting is valid. Validation checks to see that the value entered falls within the parameter setting range. A changing of the NUM_X1_TS makes a number of other changes to various rules in the system. One such parameter affected by a change in the NUM_X1_TS is the CRC4_MODE parameter. As the Table 1 parameter setting for CRC4_MODE shows, there are four possible parameter settings for CRC4_MODE. They are enable, disable, passthru, and not available. Depending upon the choice of the user for the value of the parameter NUM_X1_TS, the user is provided with a choice for the parameter setting for CRC4_MODE.

If the user selects NUM_X1_TS=32, CRC4_MODE is forced into its not available state. This triggers two processes in the systems operation module. The first is that the validation for the CRC4_MODE parameter is changed to only allow not available as a selection. The second is that the information database is changed to indicate that not available is the current mode in which the system CRC4_MODE parameter is operating.

If NUM_X1_TS is not selected as 32, the user may then select one of remaining three parameter settings, enable, disable, or passthru, but not available is no longer a valid option.

Finally, the actual configuration change is effected. In the final configuration change, for changing the NUM_X1_TS parameter, the new information is written to the configuration database. For example, if the user sets NUM_X1_TS=32, the change is validated, updated, and written to the database. Further, the system hardware is set up to pass 32 time slots of information for the E1 interface.

The methods shown in FIG. 3 may be implemented in whole or in part in various embodiments in a machine readable medium comprising machine readable instructions for causing a computer, telecommunications system with a processor, line card, or the like to perform the methods. In a computer 400 as shown in FIG. 4, the computer programs run on a central processing unit 402 out of main memory 404, and may be transferred to main memory from permanent storage 406 via disk drive or CD-ROM drive when stored on removable media or via a network connection 408 or modem connection when stored outside of the computer 400, or via other types of computer or machine readable media from which it can be read and utilized.

Such machine readable media may include software modules and computer programs. The computer programs may comprise multiple modules or objects to perform the methods in FIG. 3 or the functions of various apparatuses of FIGS. 1 and 2. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### CONCLUSION

The various embodiments of the present invention provide a method and apparatus for centralizing system change events in a telecommunications system. A systems operation module according to various embodiments of the invention provides a centralized point for all system operations that affect a change to the system. The gathering of all of the system change events, functions, and operations that affect the system allows easy addition of new parameters, changes of existing parameters, addition of new settings for parameters, and the like. Adding new features and expanding the feature set of the system is made much easier because the code for the changes is not spread out over many different modules, but is instead gathered in a single location.

The method embodiments of validating configuration changes, updating the validated configuration changes, changing the parameter rules if necessary, and writing new configuration information back to a central database provides one database and method for effecting system wide changes without the need for consultation of all pieces of code for every such change.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for effecting a configuration change in a telecommunications system, comprising:
receiving a request for a system change;
performing a plurality of checks to determine if the current setting of the particular configuration allows the requested change;
updating the system; and
carrying out the requested change.

2. The method of claim 1, wherein performing a plurality of checks comprises:
determining whether the system change request is allowed by a current system configuration.

3. The method of claim 2, wherein determining comprises:
consulting an information database for a valid parameter setting for the system change request.

4. The method of claim 1, wherein updating the system comprises:
changing the rules for other parameters in the system depending upon the current system change request; and
changing the configuration in response to the change request.

5. The method of claim 4, wherein changing the rules comprises:
consulting a set of system change parameter rules for the requested system change;
consulting a set of other parameter rules for any parameters affected by the requested system change; and
changing the available other parameter rules for each other parameter affected by the requested system change to allow only those other parameter rules that are available given the requested system change.

6. The method of claim 5, wherein changing the configuration comprises:
modifying a set of parameter rules for any other parameter required by the requested system change.

7. The method of claim 1, wherein carrying out the configuration change comprises:
storing the system change; and
making changes to hardware in the system affected by the system change.

8. A method for effecting a requested system change in a telecommunications system, comprising:
performing a plurality of checks to determine if the current setting of the particular configuration allows the requested change;
updating the system; and
carrying out the configuration change.

9. A method for operating a systems operation module in a telecommunications system, comprising:
receiving a request for a system change;
determining changes to be made to the system to effect the system change; and
making the system change.

10. The method of claim 9, wherein determining changes to be made to the system comprises:
consulting an information database for a rule set for the requested system change; and
reconciling the requested system change with all system parameters affected by the requested system change.

11. The method of claim 10, wherein reconciling comprises:
configuring available options for affected parameters according to the rule set for the requested system change.

12. The method of claim 9, wherein making the system change comprises:
writing a new configuration to a system information database; and
changing hardware of the system to effect the system change.

13. A systems operation module for a telecommunications system, comprising:
a systems operation application interface to provide access functions for the system; and
a systems operation manager to control system operation.

14. The systems operation module of claim 13, wherein the systems operation application interface comprises:
a data structure containing a plurality of rule sets for a plurality of parameters of the system, the plurality of rule sets cross referenced with one another to allow reconciling of a change in one parameter with the rules for all other parameters affected by the change in the one parameter.

15. The systems operation module of claim 13, wherein the systems operation manager further comprises a computer program executable by a computer for causing the computer to perform a method comprising:
receiving a request for a system operation;
performing a plurality of checks to determine if the current setting of the particular configuration allows the requested change;
updating the system; and
carrying out the configuration change.

16. A telecommunications system, comprising:
a system information database containing configuration information for the system;
a plurality of modules to perform individual system functions; and
a systems operation module between the plurality of modules and the system information database, the systems operation module to control all system change events.

17. The telecommunications system of claim 16, wherein the systems operation module comprises:
a systems operation application interface to communicate with the plurality of modules to provide access functions for the system; and
a systems operation manager to control system operation.

18. The telecommunications system of claim 17, wherein the telecommunications system further includes a computer, and the systems operation manager comprises a machine readable medium for causing the computer to execute a method comprising:
receiving a requested system change;
performing a plurality of checks to determine if a current setting of a particular configuration of the system allows a requested change;
updating the system; and
carrying out the configuration change.

19. A machine readable medium comprising machine readable instructions for causing a computer to perform a method comprising:
performing a plurality of checks to determine if the current setting of the particular configuration allows the requested change;
updating the system; and
carrying out the configuration change.

20. The method of claim 19, wherein performing a plurality of checks comprises:
determining whether the system change request is allowed by a current system configuration.

21. The method of claim 20, wherein determining comprises:
consulting an information database for a valid parameter setting for the system change request.

22. The method of claim 19, wherein updating the system comprises:
changing the rules for other parameters in the system depending upon the current system change request; and
changing the configuration in response to the change request.

23. The method of claim 22, wherein changing the rules comprises:
consulting a set of system change parameter rules for the requested system change;
consulting a set of other parameter rules for any parameters affected by the requested system change; and
changing the available other parameter rules for each other parameter affected by the requested system change to allow only those other parameter rules that are available given the requested system change.

24. The method of claim 23, wherein changing the configuration comprises:
modifying a set of parameter rules for any other parameter required by the requested system change.

25. The method of claim 19, wherein carrying out the configuration change comprises:
storing the system change; and
making changes to hardware in the system affected by the system change.
